(19) United States
(12) Patent Application Publication
(10) Pub. No.: US 2026/0280741 A1
(43) Pub. Date: Sep. 17, 2026

(54) METHODS AND APPARATUSES FOR UE-SERVER CO-INFERENCE IN WIRELESS SYSTEM

(71) Applicant: LENOVO (BEIJING) LIMITED, Beijing (CN)

(72) Inventors: Wei Chen, Beijing (CN); Lintao Li, Beijing (CN); Xin Guo, Beijing (CN); Haiming Wang, Beijing (CN)

(21) Appl. No.: 19/166,707

(22) PCT Filed: Mar. 24, 2023
(86) PCT No.: PCT/CN2023/083718

§ 371 Date: Sep. 18, 2025

(51) Int. Cl. H04B 17/391; H04B 17/309

(52) U.S. Cl. CPC H04B 17/3913; H04B 17/309

(57) ABSTRACT

Embodiments of the present disclosure relate to methods and apparatuses for user equipment (UE)-server co-inference in a wireless system. According to an embodiment of the present disclosure, a server can include: a transceiver; and a processor coupled to the transceiver and configured to cause the server to: determine a first model configuration for a UE, wherein the first model configuration includes a sparsification scheme, a parameter that reflects a weight of a communication delay in a loss function, or a UE-side model; and transmit, to the UE, information indicating the first model configuration.

### TECHNICAL FIELD

Embodiments of the present application are related to wireless communication technologies, and more particularly, related to methods and apparatuses for user equipment (UE)-server co-inference.

### BACKGROUND

The significant development of communication technologies spurs a huge volume of sensory data at wireless edge networks. Meanwhile, as the computational power and storage of mobile devices keep growing, edge computing is becoming a crucial technology for future networks to enable ultra-low power and ultra-low latency applications. Particularly, with the breakthrough in artificial intelligence (AI) and deep learning, AI empowered edge learning gradually attracts extensive attentions from both academia and industry.

Edge AI systems can provide deep-learning neural network (DNN) based services in a distributed manner. For edge AI systems, three methods may be used for inference. These methods may be referred to as a server-based method, a UE-based method, and a UE-server co-inference method, respectively. The server-based method mainly offloads computation tasks from mobile devices to an edge server, while the UE-based method finishes computation tasks on a mobile device locally. The server-based method may induce excessive communication overhead, which brings challenges for supporting latency-sensitive applications. The UE-based method may achieve limited accuracy due to constrained local resources. The UE-server co-inference method can effectively reduce the communication overhead as well as improve the accuracy. Currently, details regarding the UE-server co-inference method need to be studied.

### SUMMARY OF THE APPLICATION

Embodiments of the present application at least provide a technical solution for UE-server co-inference.

According to some embodiments of the present application, a server may include: a transceiver; and a processor coupled to the transceiver and configured to cause the server to: determine a first model configuration for a UE, wherein the first model configuration includes a sparsification scheme, a parameter that reflects a weight of a communication delay in a loss function, or a UE-side model; and transmit, to the UE, information indicating the first model configuration.

In some embodiments of the present application, the processor is further configured to cause the server to: transmit, to the UE, configuration information for reporting local information of the UE, wherein the configuration information indicates content included in the local information and when to report the local information, wherein the content included in the local information includes: a quality of inference service (QoIS) of the UE; a computing capability of the UE; or an available power of the UE.

In some embodiments of the present application, the configuration information indicates: to report the local information in response to receiving an indication from the server indicating the UE to report the local information; to report the local information periodically based on a reporting periodicity; or to report the local information in response to a change of the local information.

In some embodiments of the present application, the processor is further configured to cause the server to: receive local information from the UE, wherein the local information includes: a QoIS of the UE; a computing capability of the UE; or an available power of the UE; and determine the first model configuration based at least in part on the received local information.

In some embodiments of the present application, the processor is further configured to cause the server to: transmit, to the UE, configuration information indicating a set of QoISs, wherein the local information includes one QoIS of the set of QoISs; or transmit, to the UE, configuration information indicating a set of sparsification schemes, wherein the set of sparsification schemes includes the sparsification scheme.

In some embodiments of the present application, to determine the first model configuration, the processor is configured to cause the server to: determine the sparsification scheme based at least in part on the local information; or determine the parameter based at least in part on the local information.

In some embodiments of the present application, the processor is further configured to cause the server to: determine a two-sided model based at least in part on the determined sparsification scheme and the determined parameter, wherein the two-sided model includes the UE-side model and a server-side model.

In some embodiments of the present application, the processor is further configured to cause the server to: determine a set of model configurations for the UE, wherein each model configuration includes: a corresponding sparsification scheme, a corresponding parameter that reflects a weight of a communication delay in a loss function, or a corresponding UE-side model trained based at least in part on the corresponding sparsification scheme and the corresponding parameter; and transmit the set of model configurations to the UE; and wherein the first model configuration is determined from the set of model configurations based at least in part on the determined sparsification scheme and the determined parameter.

In some embodiments of the present application, the processor is further configured to cause the server to: receive a sparsified extracted feature from the UE, wherein the sparsified extracted feature is generated based at least in part on the first model configuration; and perform inference on the sparsified extracted feature based at least in part on a server-side model corresponding to the first model configuration.

In some embodiments of the present application, the sparsification scheme is one of: a first sparsification scheme which performs sparsification based at least in part on a rectified linear unit (ReLU) activation function with boundary points changed based at least in part on controlling parameters; a second sparsification scheme which controls a peak transmitting power of the UE relative to the first sparsification scheme; or a third sparsification scheme which controls an average transmitting power of the UE relative to the first sparsification scheme.

According to some embodiments of the present application, a UE may include: a transceiver; and a processor coupled to the transceiver and configured to cause the UE to: receive, from a server, information indicating a first model configuration for the UE, wherein the first model configuration includes a sparsification scheme, a parameter that reflects a weight of a communication delay in a loss function, or a UE-side model; and deploy a model on the UE based at least in part on the received information indicating the first model configuration.

In some embodiments of the present application, the processor is further configured to cause the UE to: receive, from the server, configuration information for reporting local information of the UE, wherein the configuration information indicates content included in the local information and when to report the local information, wherein the content included in the local information includes: a QoIS of the UE; a computing capability of the UE; or an available power of the UE.

In some embodiments of the present application, the configuration information indicates: to report the local information in response to receiving an indication from the server indicating the UE to report the local information; to report the local information periodically based on a reporting periodicity; or to report the local information is reported in response to a change of the local information.

In some embodiments of the present application, the processor is further configured to cause the UE to: transmit local information to the server, wherein the local information includes: a QoIS of the UE; a computing capability of the UE; or an available power of the UE; and wherein the first model configuration is determined based at least in part on the local information.

In some embodiments of the present application, the processor is further configured to cause the UE to: receive configuration information indicating a set of QoISs from the server, wherein the local information includes one QoIS of the set of QoISs; or receive configuration information indicating a set of sparsification schemes from the server, wherein the set of sparsification schemes includes the sparsification scheme.

In some embodiments of the present application, the first model configuration is one of a set of model configurations, which is configured, pre-configured, or pre-defined to the UE.

In some embodiments of the present application, the processor is further configured to cause the UE to: perform feature extraction and sparsification via the deployed model to generate a sparsified extracted feature; and transmit the sparsified extracted feature to the server.

In some embodiments of the present application, the sparsification scheme is one of: a first sparsification scheme which performs sparsification based at least in part on an ReLU activation function with boundary points changed based at least in part on controlling parameters; a second sparsification scheme which controls a peak transmitting power of the UE relative to the first sparsification scheme; or a third sparsification scheme which controls an average transmitting power of the UE relative to the first sparsification scheme.

According to some embodiments of the present application, a method performed by a server may include: determining a first model configuration for a UE, wherein the first model configuration includes a sparsification scheme, a parameter that reflects a weight of a communication delay in a loss function, or a UE-side model; and transmitting information indicating the first model configuration to the UE.

According to some embodiments of the present application, a method performed by a UE may include: receiving, from a server, information indicating a first model configuration for the UE, wherein the first model configuration includes a sparsification scheme, a parameter that reflects a weight of a communication delay in a loss function, or a UE-side model; and deploying a model on the UE based at least in part on the received information indicating the first model configuration.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates exemplary server-based method, UE-based method, and UE-server co-inference method according to some embodiments of the present application;

FIG. 3 illustrates an exemplary UE-server co-inference system according to some embodiments of the present application;

FIG. 4 illustrates an exemplary local information reporting procedure according to some embodiments of the present application;

FIG. 5 illustrates an exemplary local information reporting procedure according to some other embodiments of the present application;

FIG. 6 illustrates an exemplary determination and configuration procedure for model configuration according to some embodiments of the present application;

FIG. 7 illustrates an exemplary determination and configuration procedure for model configuration according to some other embodiments of the present application;

FIG. 8 illustrates an exemplary UE-server co-inference procedure according to some embodiments of the present application;

FIG. 9 illustrates an exemplary UE-server co-inference procedure according to some other embodiments of the present application; and

FIG. 10 illustrates a simplified block diagram of an exemplary apparatus for UE-server co-inference according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) long term evolution (LTE) and LTE advanced, 3GPP fifth generation (5G) new radio (NR), 5G-Advanced, sixth generation (6G), and so on. It is contemplated that along with developments of network architectures and new service scenarios, all embodiments in the present application are also applicable to similar technical problems; and moreover, the terminologies recited in the present application may change, which should not affect the principle of the present application.

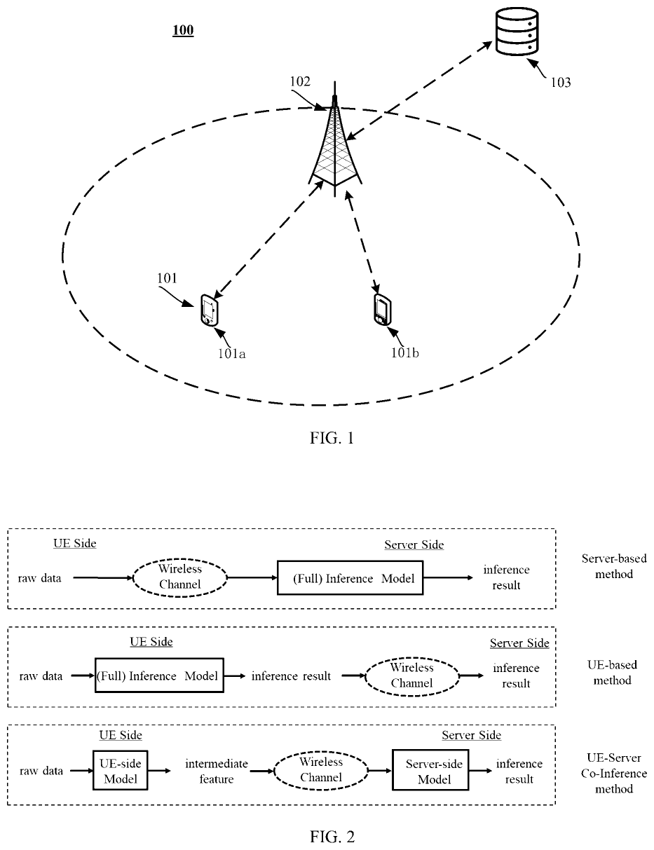

FIG. 1 illustrates an exemplary wireless communication system 100 in accordance with some embodiments of the present application.

As shown in FIG. 1, the wireless communication system 100 includes at least one UE 101, at least one base station (BS) 102, and at least one server 103. In particular, the wireless communication system 100 includes two UEs 101 (e.g., UE 101a and UE 101b), one BS 102, and one server 103 for illustrative purpose. Although a specific number of UEs 101, BS 102, and sever 103 are depicted in FIG. 1, it is contemplated that any number of UEs 101, BSs 102, and servers 103 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 101a and UE 101b in the example illustrated in FIG. 1 may transmit information to BS 102 and receive information from BS 102, for example, via LTE or NR Uu interface. BS 102 may be distributed over a geographic region. In certain embodiments of the present disclosure, BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. BS 102 is generally a part of a radio access network that may include one or more controllers communicably coupled to BS 102.

The server 103 may be an edge data network (EDN) server, a content server, a cloud server, or any other server which can determine (or learn) a global statistical model. In some embodiments of the present application, the server 103 may also be referred to as a center server. In the example illustrated in FIG. 1, the server 103 is separated from the BS 102. The server 103 may be connected to the BS 102 via a core network (not shown in FIG. 1), via a wired connection manner, via a wireless connection manner, or any other connection manners. In the example illustrated in FIG. 1, the server 103 may be connected to the BS 102 directly, other than via the core network. In some other embodiments, the sever 103 may be integrated into the BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

Edge AI systems can provide DNN-based services in a distributed manner. For edge AI systems, three methods may be used for inference. These methods may be referred to as a server-based method, a UE-based method, and a UE-server co-inference method, respectively.

FIG. 2 illustrates exemplary server-based method, UE-based method, and UE-server co-inference method according to some embodiments of the present application.

Referring to FIG. 2, in the server-based method, a UE may wirelessly transmit raw data (e.g., a picture) to a server, and the server may deploy a (full) inference model and perform inference on the raw data via the (full) inference model to obtain an inference result. Obviously, the server-based method may induce excessive communication overhead, which brings challenges for supporting latency-sensitive applications. Thus, the main challenge for the server-based method lies in the communication bottleneck.

In the UE-based method, a UE may deploy a (full) inference model and perform inference on raw data to obtain an inference result, and then wirelessly transmit the inference result to a server. Consequently, the UE-based method may achieve limited inference accuracy due to constrained local resources. Therefore, the main challenge for the UE-based method results from the computation bottleneck.

The UE-server co-inference method can effectively remove the computation and communication bottlenecks. As shown in FIG. 2, in the UE-server co-inference method, a large neural network model is split into two parts. One part of the model (e.g., UE-side model) is deployed at a UE, which has a lower requirement on the computational power. The other part of the model (e.g., server-side model) is deployed at a server, which has a relatively heavy computation load and requires a higher computational power. In the UE-server co-inference method, the UE may transform raw data into an intermediate feature via the UE-side model, and then wirelessly transmit the intermediate feature to the server. The server may perform inference on the intermediate feature via the server-side model to obtain an inference result. In this way, the system can finish the inference effectively.

The UE-server co-inference method can effectively reduce the communication overhead as well as improve the inference accuracy. However, there are still some issues needed to be solved for the UE-server co-inference method.

One issue is how to achieve a better accuracy-latency tradeoff for a distributed AI system.

Specifically, for a distributed AI system, communication is a critical bottleneck in terms of delay budget. For example, the distributed AI system usually includes a massive number of UEs, and directly transmitting the intermediate features from these UEs to a server may result in low efficiency in communication due to limited resources such as bandwidth and power. To improve efficiency in communication, sparsification may be performed on the intermediate features such that the task-related information of the intermediate features may be selected and sent, while the non-task-related information of the intermediate features may be dropped. However, the inference accuracy may be affected due to the dropped information. To achieve a better accuracy-latency tradeoff, it is essential to design a sparsification scheme.

Another issue is how to take the heterogeneity of UEs into account. For example, in a distributed AI system, UEs may have heterogeneity in available computation and communication resources. Thus, the design of the sparsification scheme needs to consider the influence of UEs' heterogeneity.

A yet another issue is how to keep it identical for the model at the UE side and the model at the server side, which may be further divided into two cases. In the first case, keeping it identical for the model at the UE side and the model at the server side may refer to that the UE-side model is the same as the server-side model. In the second case, keeping it identical for the model at the UE side and the model at the server side may refer to that both the UE-side model and the server-side model work together to construct a complete model. Embodiments of the present application focus on the second case. For example, in the UE-server co-inference method, a server may train a model and transmit a part of the model (which is referred to as a UE-side model) to a UE, which may deploy and run the UE-side model. During the inference phase, the configuration for the UE-side model needs to be identical at the UE side and at the server side to ensure a higher inference accuracy. Accordingly, how to keep it identical for the model at the UE side and the model at the server side, especially the second case as stated above, also needs to be solved.

Given the above, embodiments of the present application provide solutions for UE-server co-inference. For example, embodiments of the present application provide several solutions regarding configurations, signaling, and procedures for UE-server co-inference, which can solve at least one of the above issues. More details will be described in the following text in combination with the appended drawings.

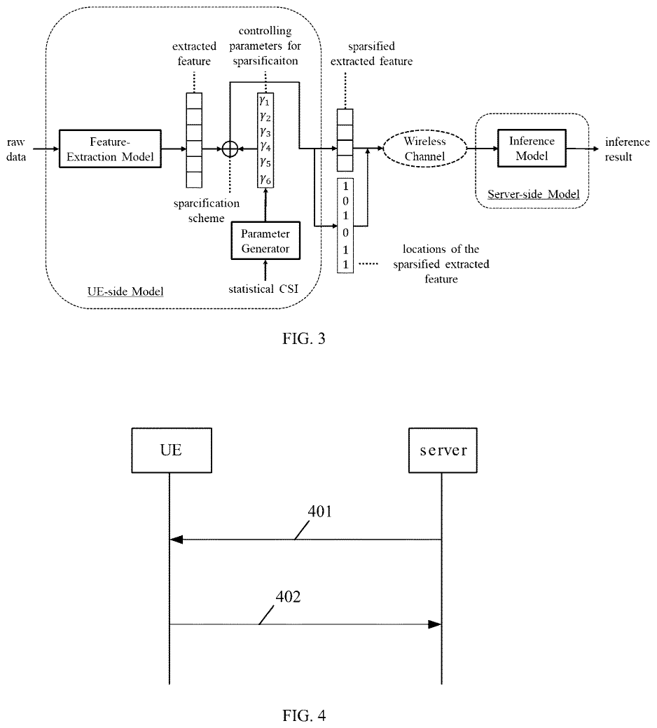

FIG. 3 illustrates an exemplary UE-server co-inference system according to some embodiments of the present application. For simplicity, the example in FIG. 3 only shows a UE and a server included in the UE-server co-inference system. It is contemplated that the UE-server co-inference system may include any number of UEs, and each UE and the server may deploy corresponding models and perform corresponding operations as illustrated in FIG. 3.

The UE may deploy a UE-side model, as shown in FIG. 3. The UE-side model may include a feature-extraction model and a parameter generator.

The input for the feature-extraction model is raw data. The feature-extraction model may transform the raw data into an extracted feature (e.g., a multiple-dimensional extracted feature). Accordingly, the output of the feature-extraction model is the extracted feature. For example, the extracted feature may include components (or elements) denoted as xᵢ, i=1, . . . , N, where each component represents one dimension of feature, and N is the total number of dimensions of the extracted feature. In the example of FIG. 3, N=6.

The input for the parameter generator is statistical channel state information (CSI). The parameter generator may provide controlling parameters for spasification based on the statistical CSI. Accordingly, the output of the parameter generator is the controlling parameters for sparsificaiton. For each dimension of feature xᵢ, the parameter generator may provide a corresponding controlling parameter. For example, the controlling parameters may be denoted as γᵢ, i=1, . . . , N. In the example of FIG. 3, the controlling parameters are γ₁, γ₂, γ₃, γ₄, γ₅, and γ₆,

In the UE-side model, the UE may transform the extracted feature into a sparsified extracted feature based on the controlling parameters for spasification and a spasification scheme (which will be described in detail later). Accordingly, the output of the UE-side model may include the sparsified extracted feature.

In some embodiments, the output of the UE-side model may also include information indicating locations of the sparsified extracted feature. The locations of the sparsified extracted feature refer to locations of components (or elements) of the sparsified extracted feature in the extracted feature. In some embodiments, the information indicating the locations of the sparsified extracted feature may be a bitmap, wherein each bit in the bitmap may correspond to a component of the extracted feature and indicate whether the component is included in the sparsified extracted feature. In the example of FIG. 3, the extracted feature includes x₁, x₂, x₃, x₄, x₅, and x₆, the sparsified extracted feature includes x₁, x₃, x₅, and x₆, and the bitmap is 101011 to indicate that the components of the sparsified extracted feature are the first, third, fifth and sixth components in the extracted feature. In some other embodiments, the locations of the sparsified extracted feature may be indicated by other means, such as a group of indices of the components in the extracted feature, e.g., 1, 3, 5, and 6.

The UE may transmit the sparsified extracted feature as well as the information indicating the locations of the sparsified extracted feature to the server via a wireless channel.

The server may deploy a server-side model, as shown in FIG. 3. The server-side model may include an inference model. In response to receiving the sparsified extracted feature as well as the information indicating the locations of the sparsified extracted feature, the server may perform inference on the sparsified extracted feature based on the server-side model to obtain an inference result. For example, the server may determine an N-dimensional feature based on the sparsified extracted feature and the locations of the sparsified extracted feature, and perform inference on the N-dimensional feature.

According to some embodiments of the present application, the server may determine the server-side model and a model configuration for the UE to deploy the UE-side model. The server-side model and the model configuration for the UE may be determined based on local information from the UE. The following embodiments provide several solutions regarding the local information, how to determine the model configuration and the server-side model, and how to perform the UE-server co-inference.

FIG. 4 illustrates an exemplary local information reporting procedure according to some embodiments of the present application. The method illustrated in FIG. 4 may be performed by two network entities, e.g., a UE and a server. In the example of FIG. 4, the server may be integrated into a BS. Accordingly, the operations performed by the server may also be deemed as the operations performed by the BS.

Although the method is illustrated in a system level, persons skilled in the art can understand that the method implemented in the two network entities can be separately implemented and incorporated in other apparatus with the like functions. Although the example in FIG. 4 shows only one UE, it is contemplated that the UE-server co-inference system may include any number of UEs, and each UE may perform the operations as illustrated in FIG. 4 to interact with the server.

Referring to FIG. 4, in step 401, the server may transmit, to the UE, configuration information for reporting local information of the UE. The configuration information may indicate content included in the local information and when to report the local information. In some embodiments, the configuration information may be transmitted to the UE via at least one of: a system information block (SIB) message, a master information block (MIB) message, an RRC signaling, a medium access control (MAC) control element (CE), or downlink control information (DCI).

In some embodiments, the content included in the local information may include at least one of: a QoIS of the UE; a computing capability of the UE; or an available power of the UE.

In some embodiments, the configuration information may indicate: to report the local information in response to receiving an indication from the server indicating the UE to report the local information; to report the local information periodically based on a reporting periodicity; or to report the local information in response to a change of the local information. In an embodiment, in the case that the configuration information indicates to report the local information periodically based on a reporting periodicity, the configuration information may also indicate the reporting periodicity.

Consequently, in step 401, the UE may receive the configuration information from the server. Then, in step 402, the UE may transmit the local information to the server based at least in part on the configuration information.

In an aspect, the local information may include the content indicated by the configuration information. For example, the local information transmitted by the UE may include at least one of: a QoIS of the UE; a computing capability of the UE; or an available power of the UE, as indicated by the configuration information.

The QoIS may reflect the UE's requirements on latency and inference accuracy. In some embodiments, the server may transmit configuration information (e.g., via an RRC signaling) indicating a set of QoISs. Each QoIS within the set of QoISs may be denoted by a value (or a level) and indicate a corresponding latency requirement and a corresponding inference accuracy requirement. In such embodiment, the QoIS included in the local information transmitted in step 402 may be one of the set of QoISs. For example, the set of QoISs may include 5 QoISs, which are denoted by “0,” “1,” “2,” “3,” and “4,” respectively, wherein “0” may represent the lowest latency and the highest inference accuracy required by the UE. In such example, the UE may transmit the local information including a QoIS value of “0” to indicate that it requires the lowest latency and the highest inference accuracy.

In another aspect, when to transmit the local information may be based on the configuration information.

As an example, in the case that the configuration information indicates to report the local information in response to receiving an indication from the server indicating the UE to report the local information, the UE may transmit the local information when receiving such an indication from the server.

As another example, in the case that the configuration information indicates to report the local information periodically based on a reporting periodicity, the UE may transmit the local information periodically based on the reporting periodicity.

As yet another example, in the case that the configuration information indicates to report the local information in response to a change of the local information, the UE may transmit the local information when the local information changes. For example, a change of the local information may include a change in value(s) (or level(s)) of at least one of a QoIS of the UE, a computing capability of the UE, or an available power of the UE.

Consequently, in step 402, the server may receive the local information transmitted from the UE.

In some embodiments of the present application, step 401 may be not performed before the UE transmits local information to the server. The content included in the local information and the timing to transmit the local information may be similar to those described above.

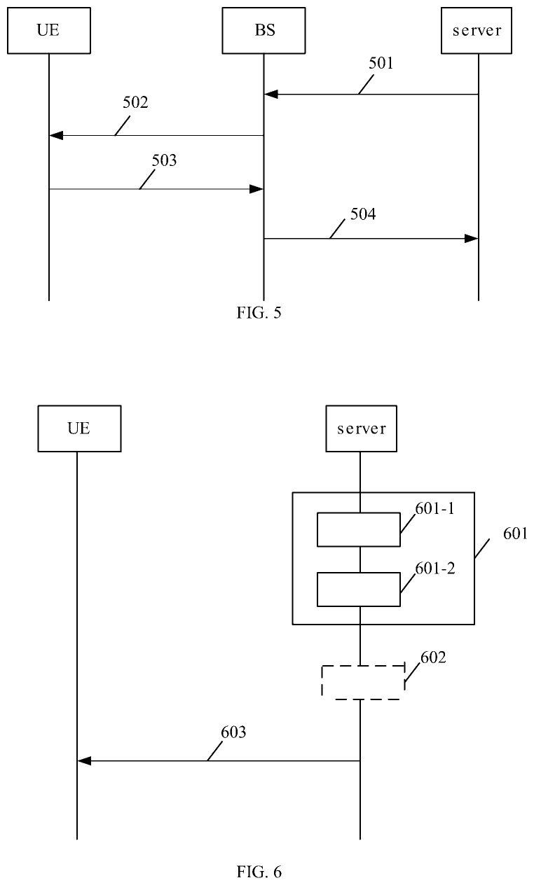

FIG. 5 illustrates an exemplary local information reporting procedure according to some other embodiments of the present application. The method illustrated in FIG. 5 may be performed by three network entities, e.g., a UE, a BS and a server. In other words, in the example of FIG. 5, the server may be separated from the BS.

Although the method is illustrated in a system level, persons skilled in the art can understand that the method implemented in the three network entities can be separately implemented and incorporated in other apparatus with the like functions. Although the example in FIG. 5 shows only one UE, it is contemplated that the UE-server co-inference system may include any number of UEs, and each UE may perform the operations as illustrated in FIG. 5 to interact with a BS and the server.

Referring to FIG. 5, in step 501, the server may transmit, to the BS, configuration information for reporting local information of the UE. All the definitions regarding the configuration information as described with respect to FIG. 4 may also apply here.

In step 502, the BS may transmit the configuration information to the UE, e.g., via an RRC signaling.

Steps 501 and 502 may be deemed as the server transmitting the configuration information to the UE via the BS.

In response to receiving the configuration information, in step 503, the UE may transmit the local information to the BS based at least in part on the configuration information. Step 503 may be performed similarly to step 402.

In response to receiving the local information from the UE, in step 504, the BS may transmit the local information to the server.

Steps 503 and 504 may be deemed as the UE transmitting the location information to the server via the BS.

In some embodiments of the present application, steps 501 and 502 may not be performed before the UE transmits local information to the server. The content included in the local information and the timing to transmit the local information may be similar to those described above.

According to some embodiments of the present application, based on the local information of the UE, the serve may determine a model configuration for the UE to deploy a model and determine a server-side model to be deployed by the server itself. The following embodiments provide solutions regarding how to determine the model configuration and the server-side model based on the local information.

FIG. 6 illustrates an exemplary determination and configuration procedure for model configuration according to some embodiments of the present application. The method illustrated in FIG. 6 may be performed by two network entities, e.g., a UE and a server. In the example of FIG. 6, the server may be integrated into a BS. Accordingly, the operations performed by the server may also be deemed as the operations performed by the BS.

Although the method is illustrated in a system level, persons skilled in the art can understand that the method implemented in the two network entities can be separately implemented and incorporated in other apparatus with the like functions. Although the example in FIG. 6 shows only one UE, it is contemplated that the UE-server co-inference system may include any number of UEs, and each UE perform the operations as shown in FIG. 6 to interact with the server.

Referring to FIG. 6, in step 601, the server may determine a first model configuration for the UE to deploy a UE-side model (e.g., the UE-side model as shown in FIG. 3). The first model configuration may include at least one of a sparsification scheme, a parameter (also referred to as a hyperparameter, e.g., denoted by β) that reflects a weight of a communication delay in a loss function, or a UE-side model. The sparsification scheme may be used by the UE for generating a sparsified extracted feature, as shown in FIG. 3. β may be used in the feature-extraction model as shown in FIG. 3. The UE-side model may include other parameters (except for β and the sparsification scheme) of the UE-side model. For example, the other parameters of the UE-side model may include parameters for deploying and/or running the feature-extraction model and the parameter generator.

After determining the first model configuration, in step 603, the server may transmit information indicating the first model configuration to the UE.

According to some embodiments of the present application, the first model configuration may be determined based on the local information received from the UE, e.g., the local information received in step 402.

Step 601 may include sub-step 601-1 and sub-step 601-2.

In some embodiments, in sub-step 601-1, the server may determine the sparsification scheme based at least in part on the local information.

For example, based on the computing capability of the UE, the server may determine a computation time of the UE. Then, based on the QoIS of the UE, the server may determine the maximum communication delay for the UE. To meet the constraint on the maximum communication delay, the server may determine a transmission scheme, which is related to the available power of the UE and an aim of power control, e.g., to control a peak transmitting power or average transmitting power of the UE. Based on all the above factors, the server may determine a sparsification scheme to be used by the UE.

The sparsification scheme determined by the server may be any of sparsification scheme 1, sparsification scheme 2, or sparsification scheme 3 as described below, or any other sparsification schemes in existing technologies.

Sparsification scheme 1 may have the best performance on the inference accuracy with a high average transmitting power consumption. Sparsification scheme 1 may perform sparsification based at least in part on a ReLU activation function with boundary points changed based at least in part on controlling parameters. For example, it is assumed that each component of the extracted feature (e.g., a multiple-dimensional extracted feature) is denoted by xᵢ, i=1, . . . , N, where N is the total number of dimensions of the extracted feature, and for xᵢ, the corresponding controlling parameter provided by the parameter generator is denoted by γᵢ, i=1, . . . , N. In sparsification scheme 1, the sparsified extracted feature (e.g., denoted by yᵢ) may be determined based on the following formula (1):

$${y}_{i} = \{ \begin{matrix}0 , & {x}_{i} < {γ}_{i} \\ {x}_{i} - {γ}_{i} , & {x}_{i} \geq {γ}_{i}\end{matrix} \qquad ( 1 )$$

It can be seen from formula (1) that the sparsified extracted feature does not rely on any hyperparameter, which avoids the influence of unreasonable hyperparameter choice. In addition, it can also be seen from formula (1) that the sparsified extracted feature not only relates to CSI, but also relates to the raw data, which may have the advantage of better considering the difference of various inputs for the model. In addition, by adopting sparsification scheme 1, a malicious client which wants to recover the UE's extracted feature has to collect yᵢ and γᵢ simultaneously. However, γᵢ is kept in the UE without transmission. Therefore, sparsification scheme 1 also protects UE's privacy.

Sparsification scheme 2 may control a peak transmitting power (e.g., peak signal-to-noise ratio (SNR)) of the UE relative to sparsification scheme 1. For example, in sparsification scheme 2, the sparsified extracted feature may be determined based on the following formula (2):

$${y}_{i} = \{ \begin{matrix}0 , & {x}_{i} < {γ}_{i} \\ tanh ( {x}_{i} - {γ}_{i} ) , & {x}_{i} \geq {γ}_{i}\end{matrix} \qquad ( 2 )$$

Sparsification scheme 3 may control an average transmitting power (e.g., average SNR) of the UE relative to sparsification scheme 1. For example, in sparsification scheme 3, the sparsified extracted feature may be determined based on the following formula (3):

$${y}_{i} = \{ \begin{matrix}0 , & {x}_{i} < {γ}_{i} \\ c ( {x}_{i} - {γ}_{i} ) , & {x}_{i} \geq {γ}_{i}\end{matrix} \qquad ( 3 )$$

wherein 0<c<1.

It is contemplated that sparsification schemes 1-3 may be implemented in other forms.

In some examples, the server may transmit configuration information (e.g., via an RRC signaling) indicating a set of sparsification schemes to the UE. For example, the set of sparsification schemes may include at least one of: sparsification scheme 1, sparsification scheme 2, sparsification scheme 3, or one or more other sparsification schemes in existing technologies. Each sparsification scheme in the set of sparsification schemes may be associated with a corresponding index. The server may determine a sparsification scheme to be used by the UE from the set of sparsification schemes.

In some embodiments, in sub-step 601-1, the server may determine β based at least in part on the local information. For example, a higher value of β may mean that the influence of the communication delay is greater during the model training process.

For example, based on the QoIS of the UE, the server may determine the UE's requirement on inference accuracy. If the QoIS indicates a high inference accuracy, then the server may determine a small value for β to ensure the inference accuracy.

After determining the sparsification scheme and β, in sub-step 601-2, the UE may determine the first model configuration based on the determined sparsification scheme and the determined β.

In some embodiments, the server may determine a two-sided model based at least in part on the determined sparsification scheme and the determined B. The two-sided model may include the UE-side model and a server-side model. In other words, once the two-sided model is determined, the UE-side model is determined, and thus the first model configuration is determined.

In such embodiments, the information indicating the first model configuration transmitted in step 603 may include at least one of: the determined β, an index of the determined sparsification scheme, or the determined UE-side model.

The following examples provide several solutions regarding how to determine a two-sided model based at least in part on the determined sparsification scheme and the determined parameter.

As an example, the server may determine the two-sided model by means of training the two-sided model based on the determined sparcification scheme and the determined β.

As another example, the server may train a set of two-sided models offline, wherein each two-sided model includes a corresponding UE-side model and a corresponding server-side model and is trained based on a corresponding β within a set of Bs and a corresponding sparsification scheme within a set of sparsification schemes. Then, based on the sparcification scheme and β determined in sub-step 601-1, the server may determine a two-sided model corresponding to the determined sparsification scheme and the determined β from the set of two-sided models.

In some other embodiments, the first model configuration may be one of a set of model configurations, wherein each model configuration may include: a corresponding sparsification scheme, a corresponding β, or a corresponding UE-side model trained based at least in part on the corresponding sparsification scheme and the corresponding β. For example, based on the corresponding sparsification scheme and the corresponding β, the server may train a corresponding two-sided model including a corresponding UE-side model and a corresponding server-side model. Given this, each model configuration within the set of model configurations may correspond to a UE-side model and a server-side model. Each model configuration included in the set of model configurations may be associated with an index.

The set of model configurations may be configured, pre-configured, or pre-defined to the UE.

Configuring the set of model configurations to the UE may refer to that the set of model configurations is transmitted by the server to the UE via at least one of: a SIB message, a MIB message, an RRC signaling, a MAC CE, or DCI, such that the UE may receive the set of model configurations from the server.

Pre-configuring or pre-defining the set of model configuration to the UE may refer to that: the set of model configurations may be hard-wired into the UE or stored on a subscriber identity module (SIM) or universal subscriber identity module (USIM) card for the UE, such that the UE may obtain the set of model configurations within the UE.

In such embodiments, based on the determined sparcification scheme and the determined B, the server may determine the first model configuration which includes the determined sparcification scheme and the determined β from the set of model configurations.

In such embodiments, the information indicating the first model configuration transmitted in step 603 may include an index of the first model configuration. In some examples, the information indicating the first model configuration may be transmitted via at least one of: a SIB message, a MIB message, an RRC signaling, or a MAC CE, or DCI.

In some embodiments of the present application, an optional step 602 may be performed, in which the server may determine resources (e.g., bandwidth) for transmitting the sparsified extracted feature by the UE. In some examples, the resources may be determined based on the QoIS of the UE, the available power of the UE, and the determined β.

As an example, the QoIS of the UE may indicate that the UE requires both low latency and high inference accuracy, and then the determined β may have a small value to achieve the high inference accuracy. However, β with a small value may cause a large amount of information to be transmitted. To ensure the low latency for the UE, the server may allocate a bandwidth for transmitting the sparsified extracted feature by the UE with the consideration of the available power of the UE.

As another example, the QoIS of the UE may indicate both high latency and low inference accuracy required by the UE, and then the determined β may have a large value. β with a large value may indicate that there is less information to be transmitted. Then, the server may allocate less bandwidth for transmitting the sparsified extracted feature by the UE.

In some embodiments, the server may store a lookup table. The lookup table may include at least one entry, and each entry may indicate a corresponding bandwidth and corresponding UE information (e.g., at least one of: QoIS, available power, and β). Then, based on UE information, the server may determine the corresponding bandwidth according to the lookup table. For example, the lookup table may be determined by an application layer and configured to the server.

Compared with a method where a unified bandwidth is applied for transmitting the sparsified extracted feature by the UE, the operations in step 602 may achieve a balance between inference accuracy and DL transmission resources. Moreover, the operations in step 602 may decrease signaling and delay compared to traditional resource allocation which is triggered by an explicit scheduling request from a UE to a BS (or server).

In the case that step 602 is performed, in step 603, the server may also transmit information indicating the determined resources to the UE, e.g., via at least one of: a SIB message, a MIB message, an RRC signaling, or a MAC CE, or DCI.

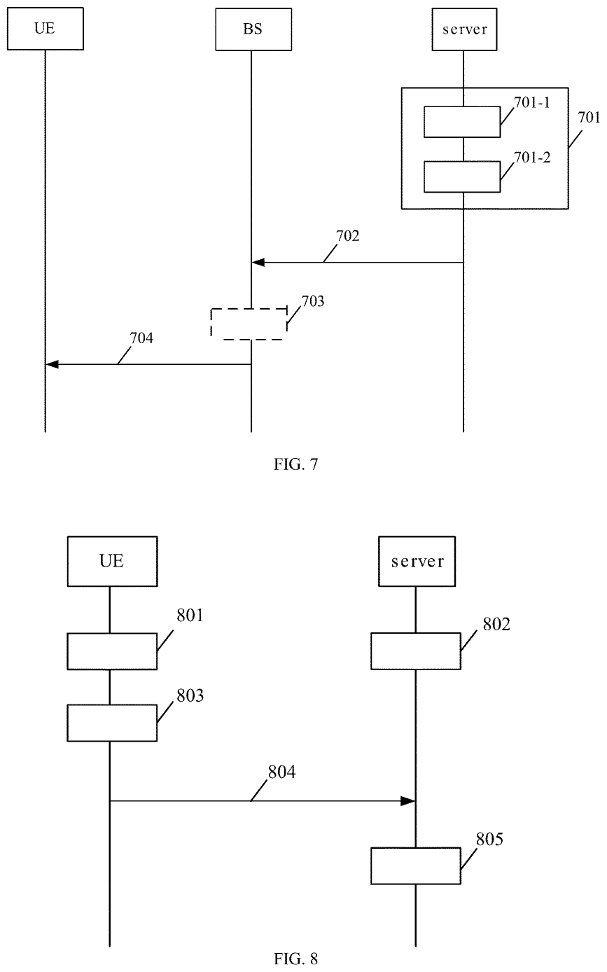

FIG. 7 illustrates an exemplary determination and configuration procedure for model configuration according to some other embodiments of the present application. The method illustrated in FIG. 7 may be performed by three network entities, e.g., a UE, a BS and a server. In other words, in the example of FIG. 7, the server may be separated from the BS.

Although the method is illustrated in a system level, persons skilled in the art can understand that the method implemented in the three network entities can be separately implemented and incorporated in other apparatus with the like functions. Although the example in FIG. 7 shows only one UE, it is contemplated that the UE-server co-inference system may include any number of UEs, and each UE may perform the operations as illustrated in FIG. 7 to interact with a BS and the server.

Referring to FIG. 7, in step 701, the server may determine a first model configuration for the UE to deploy a UE-side model (e.g., the UE-side model as shown in FIG. 3). The operations performed in step 701 may be the same as those performed in step 601. For example, step 701 may include sub-step 701-1 and sub-step 701-2. All the operations performed in sub-step 601-1 may apply to sub-step 701-1, and all the operations performed in sub-step 601-2 may apply to sub-step 701-2.

After determining the first model configuration, in step 702, the server may transmit information indicating the first model configuration to the BS. All the definitions regarding the information indicating the first model configuration as described with respect to FIG. 6 may also apply here. After receiving the information indicating the first model configuration, in step 704, the BS may transmit it to the UE, e.g., via at least one of: a SIB message, a MIB message, an RRC signaling, or a MAC CE, or DCI. Steps 702 and 704 may be deemed as the server transmitting the first model configuration to the UE via the BS.

In some embodiments of the present application, an optional step 703 may be performed, in which the BS may determine resources (e.g., bandwidth) for transmitting the sparsified extracted feature by the UE. The operations performed in step 703 may be similar to those performed in step 602. In the case that step 703 is performed, in step 704, the BS may also transmit information indicating the determined resources to the UE, e.g., via at least one of: a SIB message, a MIB message, an RRC signaling, or a MAC CE, or DCI.

FIG. 8 illustrates an exemplary UE-server co-inference procedure according to some embodiments of the present application. The method illustrated in FIG. 8 may be performed by two network entities, e.g., a UE and a server. In the example of FIG. 8, the server may be integrated into a BS. Accordingly, the operations performed by the server may also be deemed as the operations performed by the BS.

Although the method is illustrated in a system level, persons skilled in the art can understand that the method implemented in the two network entities can be separately implemented and incorporated in other apparatus with the like functions. Although the example in FIG. 8 shows only one UE, it is contemplated that the UE-server co-inference system may include any number of UEs, and each UE may perform the operations as shown in FIG. 8 to interact with the server.

Referring to FIG. 8, in response to receiving information indicating first model configuration for the UE to deploy a UE-side model (e.g., the information transmitted in step 603), in step 801, the UE may deploy a model (e.g., the UE-side model as shown in FIG. 3) on the UE based at least in part on the received information indicating the first model configuration. For example, based on the UE-side model included in the first model configuration, the UE may deploy the feature-extraction model and the parameter generator as shown in FIG. 3.

In some embodiments, the first model configuration may indicate a sparsification scheme used in the UE-side model and a parameter (also referred to as a hyperparameter, e.g., denoted by β) that reflects a weight of a communication delay in a loss function and is used in the feature-extraction model.

In step 802, the server may deploy a server-side model corresponding to the first model configuration. The server-side model corresponding to the first model configuration may refer to that a two-sided model including the server-side model and the UE-side model may be determined (e.g., trained) based on the sparsification scheme and β included in the first model configuration.

In step 803, the UE may perform feature extraction and sparsification via the deployed model to generate a sparsified extracted feature. Then, in step 804, the UE may transmit the sparsified extracted feature (and the locations of the sparsified extracted feature in some cases) to the server.

In response to receiving the sparsified extracted feature (and the locations of the sparsified extracted feature in some cases) in step 804, in step 805, the server may perform inference on the sparsified extracted feature based at least in part on the server-side model to generate an inference result.

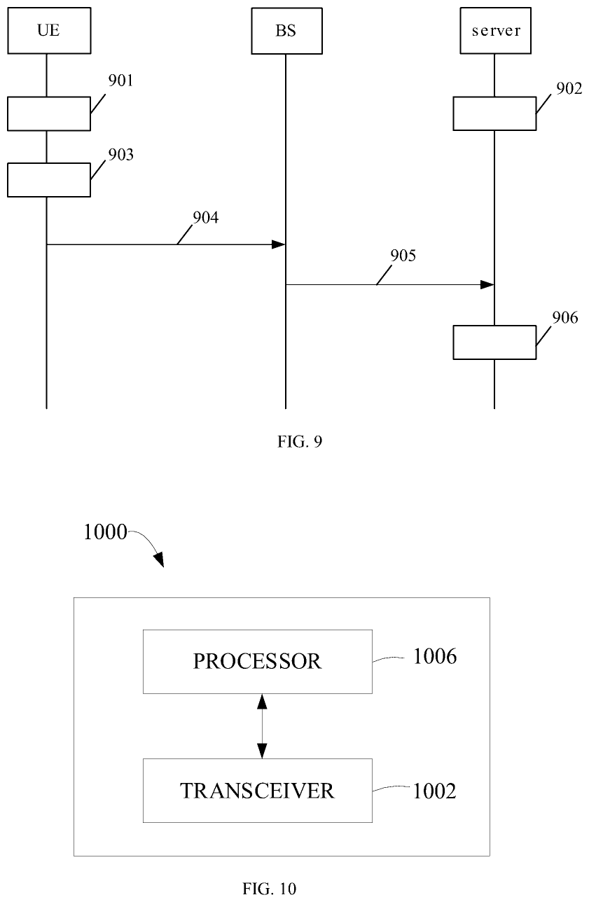

FIG. 9 illustrates an exemplary UE-server co-inference procedure according to some other embodiments of the present application. The method illustrated in FIG. 9 may be performed by three network entities, e.g., a UE, a BS and a server. In other words, in the example of FIG. 9, the server may be separated from the BS.

Although the method is illustrated in a system level, persons skilled in the art can understand that the method implemented in the three network entities can be separately implemented and incorporated in other apparatus with the like functions. Although the example in FIG. 9 shows only one UE, it is contemplated that the UE-server co-inference system may include any number of UEs, and each UE may perform the operations as illustrated in FIG. 9 to interact with a BS and the server.

The operations performed in steps 901, 902, 903, and 906 may be the same as those performed in steps 801, 802, 803, and 805, respectively, and thus are omitted herein for simplicity.

After generating a sparsified extracted feature in step 903, in step 904, the UE may transmit the sparsified extracted feature (and the locations of the sparsified extracted feature in some cases) to the BS. Then, in step 905, the BS may transmit the sparsified extracted feature (and the locations of the sparsified extracted feature in some cases) to the server. Steps 904 and 905 may be deemed as the UE transmitting the sparsified extracted feature to the server via the BS.

FIG. 10 illustrates a simplified block diagram of an exemplary apparatus 1000 for UE-server co-inference according to some embodiments of the present application. In some embodiments, the apparatus 1000 may be or include at least part of a UE (e.g., UE 101a or UE 101b in FIG. 1). In some other embodiments, the apparatus 1000 may be or include at least part of a server (e.g., server 103 in FIG. 1).

Referring to FIG. 10, the apparatus 1000 may include at least one transceiver 1002 and at least one processor 1006. The at least one transceiver 1002 is coupled to the at least one processor 1006.

Although in this figure, elements such as the transceiver 1002 and the processor 1006 are illustrated in the singular, the plural is contemplated unless a limitation to the singular is explicitly stated. In some embodiments of the present application, the transceiver 1002 may be divided into two devices, such as receiving circuitry (or a receiver) and transmitting circuitry (or a transmitter). In some embodiments of the present application, the apparatus 1000 may further include an input device, a memory, and/or other components. The transceiver 1002 and the processor 1006 may be configured to perform any of the methods described herein (e.g., the methods described with respect to FIGS. 3-9 or other methods described in the embodiments of the present application).

According to some embodiments of the present application, the apparatus 1000 may be a server, and the transceiver 1002 and the processor 1006 may be configured to perform operations of a server in the methods as described with respect to FIGS. 3-9 or other methods described in the embodiments of the present application. For example, the processor 1006 is configured to cause the server to: determine a first model configuration for a UE, wherein the first model configuration includes a sparsification scheme, a parameter that reflects a weight of a communication delay in a loss function, or a UE-side model; and transmit, to the UE, information indicating the first model configuration.

According to some embodiments of the present application, the apparatus 1000 may be a UE, and the transceiver 1002 and the processor 1006 may be configured to perform operations of a UE in the methods as described with respect to FIGS. 3-9 or other methods described in the embodiments of the present application. For example, the processor 1006 is configured to cause the UE to: receive, from a server, information indicating a first model configuration for the UE, wherein the first model configuration includes an intermediate-feature sparsification scheme, a parameter that reflects a weight of a communication delay in a loss function, or a UE-side model; and deploy a model on the UE based at least in part on the received information indicating the first model configuration.

In some embodiments of the present application, the apparatus 1000 may further include at least one non-transitory computer-readable medium. In some embodiments of the present disclosure, the non-transitory computer-readable medium may have stored thereon computer-executable instructions to cause the processor 1006 to implement any of the methods as described above. For example, the computer-executable instructions, when executed, may cause the processor 1006 to interact with the transceiver 1002, so as to perform operations of the methods, e.g., as described with respect to FIGS. 3-9 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for UE-server co-inference, including a processor and a memory. Computer programmable instructions for implementing a method for UE-server co-inference are stored in the memory, and the processor is configured to perform the computer programmable instructions to implement the method for UE-server co-inference. The method for UE-server co-inference may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for UE-server co-inference according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A server, comprising:
at least one memory; and
at least one processor coupled with the at least one memory and configured to cause the server to:
determine a first model configuration for a user equipment (UE), wherein the first model configuration includes a sparsification scheme, a parameter that reflects a weight of a communication delay in a loss function, or a UE-side model; and
transmit, to the UE, information indicating the first model configuration.

2. The server of claim 1, wherein the at least one processor is configured to cause the server to:
transmit, to the UE, configuration information for reporting local information of the UE, wherein the configuration information indicates content included in the local information and when to report the local information, wherein the content included in the local information includes:
a quality of inference service (QoIS) of the UE;
a computing capability of the UE; or
an available power of the UE.

3. The server of claim 2, wherein the configuration information indicates:
to report the local information in response to receiving an indication from the server indicating the UE to report the local information;
to report the local information periodically based on a reporting periodicity; or
to report the local information in response to a change of the local information.

4. The server of claim 1, wherein the at least one processor is configured to cause the server to:
receive local information from the UE, wherein the local information includes:
a QoIS of the UE;
a computing capability of the UE; or
an available power of the UE; and
determine the first model configuration based at least in part on the received local information.

5. The server of claim 4, wherein the at least one processor is configured to cause the server to:
transmit, to the UE, configuration information indicating a set of QoISs, wherein the local information includes one QoIS of the set of QoISs; or
transmit, to the UE, configuration information indicating a set of sparsification schemes, wherein the set of sparsification schemes includes the sparsification scheme.

6. The server of claim 4, wherein, to determine the first model configuration, the at least one processor is configured to cause the server to:
determine the sparsification scheme based at least in part on the local information; or
determine the parameter based at least in part on the local information.

7. The server of claim 6, wherein the at least one processor is configured to cause the server to:
determine a two-sided model based at least in part on the determined sparsification scheme and the determined parameter, wherein the two-sided model includes the UE-side model and a server-side model.

8. The server of claim 6, wherein the at least one processor is configured to cause the server to:
determine a set of model configurations for the UE, wherein each model configuration includes: a corresponding sparsification scheme, a corresponding parameter that reflects a weight of a communication delay in a loss function, or a corresponding UE-side model trained based at least in part on the corresponding sparsification scheme and the corresponding parameter; and
transmit the set of model configurations to the UE;
wherein the first model configuration is determined from the set of model configurations based at least in part on the determined sparsification scheme and the determined parameter.

9. The server of claim 1, wherein the at least one processor is configured to cause the server to:
receive a sparsified extracted feature from the UE, wherein the sparsified extracted feature is generated based at least in part on the first model configuration; and
perform inference on the sparsified extracted feature based at least in part on a server-side model corresponding to the first model configuration.

10. The server of claim 1, wherein the sparsification scheme is one of:
a first sparsification scheme which performs sparsification based at least in part on a rectified linear unit (ReLU) activation function with boundary points changed based at least in part on controlling parameters;
a second sparsification scheme which controls a peak transmitting power of the UE relative to the first sparsification scheme; or
a third sparsification scheme which controls an average transmitting power of the UE relative to the first sparsification scheme.

11. A user equipment (UE), comprising:
at least one memory; and
at least one processor coupled with the at least one memory and configured to cause the UE to:
receive, from a server, information indicating a first model configuration for the UE, wherein the first model configuration includes a sparsification scheme, a parameter that reflects a weight of a communication delay in a loss function, or a UE-side model; and
deploy a model on the UE based at least in part on the received information indicating the first model configuration.

12. The UE of claim 11, wherein the at least one processor is configured to cause the UE to:
receive, from the server, configuration information for reporting local information of the UE, wherein the configuration information indicates content included in the local information and when to report the local information, wherein the content included in the local information includes:
a quality of inference service (QoIS) of the UE;
a computing capability of the UE; or
an available power of the UE.

13. The UE of claim 11, wherein the at least one processor is configured to cause the UE to:
transmit local information to the server, wherein the local information includes:
a QoIS of the UE;
a computing capability of the UE; or
an available power of the UE; and
wherein the first model configuration is determined based at least in part on the local information.

14. The UE of claim 11, wherein the at least one processor is configured to cause the UE to:
perform feature extraction and sparsification via the deployed model to generate a sparsified extracted feature; and
transmit the sparsified extracted feature to the server.

15. A method performed by a server, the method comprising:
determining a first model configuration for a user equipment (UE), wherein the first model configuration includes a sparsification scheme, a parameter that reflects a weight of a communication delay in a loss function, or a UE-side model; and
transmitting information indicating the first model configuration to the UE.

16. The method of claim 15, further comprising:
transmitting, to the UE, configuration information for reporting local information of the UE, wherein the configuration information indicates content included in the local information and when to report the local information, wherein the content included in the local information includes:
a quality of inference service (QoIS) of the UE;
a computing capability of the UE; or
an available power of the UE.

17. A method performed by a user equipment (UE), the method comprising:
receiving, from a server, information indicating a first model configuration for the UE, wherein the first model configuration includes a sparsification scheme, a parameter that reflects a weight of a communication delay in a loss function, or a UE-side model; and
deploying a model on the UE based at least in part on the received information indicating the first model configuration.

18. The method of claim 17, further comprising:
receiving, from the server, configuration information for reporting local information of the UE, wherein the configuration information indicates content included in the local information and when to report the local information, wherein the content included in the local information includes:
a quality of inference service (QoIS) of the UE;
a computing capability of the UE; or
an available power of the UE.

19. The method of claim 17, further comprising:
transmitting local information to the server, wherein the local information includes:
a QoIS of the UE;
a computing capability of the UE; or
an available power of the UE; and
wherein the first model configuration is determined based at least in part on the local information.

20. The method of claim 17, further comprising:
performing feature extraction and sparsification via the deployed model to generate a sparsified extracted feature; and
transmitting the sparsified extracted feature to the server.
